(19) United States
(12) Patent Application Publication
(10) Pub. No.: US 2025/0333986 A1
(43) Pub. Date: Oct. 30, 2025

(54) LATCH ASSEMBLY HAVING REMOTE - EMBEDDED CINCH/PRESENT ACTUATOR

(71) Applicant: MAGNA CLOSURES INC., Newmarket (CA)

(72) Inventors: Roman CETNAR, Newmarket (CA); Bogdan MAGLAVICEANU, Newmarket (CA)

(21) Appl. No.: 19/174,895

(22) Filed: Apr. 9, 2025

Related U.S. Application Data
(60) Provisional application No. 63/638,693, filed on Apr. 25, 2024.
(60) Provisional application No. 63/766,742, filed on Mar. 4, 2025.

(51) Int. Cl. E05B 81/20; E05B 79/20; E05B 81/06; E05B 81/30; E05B 81/34; E05B 85/02

(52) U.S. Cl. CPC E05B 81/20; E05B 79/20; E05B 81/06; E05B 81/30; E05B 81/34; E05B 85/02

(57) ABSTRACT

A latch assembly for a motor vehicle closure member includes a latch housing containing a ratchet and a pawl in a latch housing chamber and an auxiliary housing containing an actuator in an auxiliary housing chamber. The latch housing chamber and the auxiliary housing chamber are separate from one another and out of communication from one another, with at least one cable extending exteriorly between the auxiliary housing and the latch housing. The actuator is energizable to move the at least one cable to move the ratchet from a secondary striker capture position to a primary striker capture position and optionally to move another cable to move the ratchet from the primary striker capture position toward a striker release position.

### CROSS-REFERENCE TO RELATED APPLICATIONS

This application claims the benefit of U.S. Provisional Application Ser. No. 63/766,742, filed Mar. 4, 2025, and of U.S. Provisional Application Ser. No. 63/638,693, filed Apr. 25, 2024, which are incorporated herein by way of reference in their entirety.

### FIELD

The present disclosure relates generally to a latch system for a vehicle closure panel and, more particularly, to a power latch assembly having a power cinch actuator or a power cinch and power present actuator attached thereto.

### BACKGROUND

This section provides background information related to the present disclosure which is not necessarily prior art.

In view of increased consumer demand for motor vehicles equipped with advanced comfort and convenience features, many modern motor vehicles are now provided with passive entry systems to permit locking and release of closure panels (i.e., doors, tailgates, liftgates and decklids) without use of a traditional key-type entry system. In this regard, some popular features now available with vehicle latch systems include power locking/unlocking, power release, power cinching, and power presenting. These “powered” features are provided by a latch assembly mounted to the closure panel and which includes a ratchet and pawl type of latching mechanism controlled via multiple electric actuators. Typically, the closure panel is held in a closed position by virtue of the ratchet being positioned in a striker capture position to releasably retain a striker that is mounted to a structural portion of the vehicle. The ratchet is held in its striker capture position by the pawl engaging the ratchet in a ratchet holding position. In most ratchet and pawl type of latching mechanisms, the pawl is operable in a secondary ratchet holding position to retain the ratchet in a secondary striker capture position and in primary ratchet holding position to retain the ratchet in a primary striker capture position. Latch assemblies providing a power cinching operation are typically equipped with a cinching mechanism operated by an electric cinching actuator. Commonly, the cinching mechanism is directly connected to the ratchet and, when actuated, is operable for moving the ratchet from its secondary striker capture position into its primary or cinched striker capture position, thereby cinching the closure panel in its closed position. To subsequently release the closure panel from its closed position, a release mechanism is actuated for moving the pawl from its ratchet holding position into a ratchet release position, whereby a ratchet biasing arrangement forcibly pivots the ratchet from its primary striker capture position into an open position or striker release position so as to release the striker. In latch assemblies providing a power release feature, the release mechanism is typically controlled by a separate power release actuator. Latch assemblies providing a power presenting operation are typically equipped with a presenting mechanism operated by an electric presenting actuator. Commonly, the presenting mechanism is directly connected to the ratchet and, when actuated, is operable for moving the ratchet from its primary striker capture position toward its striker release position, thereby presenting the closure panel toward its open position.

With latch assemblies including power release and power cinch features, and optionally power present features, the separate power release actuator, power cinch actuator, and optionally power present actuator can be contained in a common, single housing. Although this can be useful in assembly, having only to attach a single housing to the closure panel, it comes with a drawback. If a version of the latch assembly not having the power cinching feature and/or power presenting feature is desired, the housing needs to be redesigned, thereby adding complexity of having to have different versions of the housing for different latch versions, while also adding cost.

Otherwise, the separate power release actuator, power cinch actuator, and power present actuator can be contained in separate housings as separate components spaced from the power release actuator housing. Although this does not require redesign of the different housings, it comes with a drawback of having to mount the separate housings to separate components, which adds handling complexity during assembly, while also adding steps by having to mount the different components separately from one another and interconnect the separate components via separately routed cables. Further, separate locations need to be provided for mounting, and additional fasteners are required to fasten the separate components to the closure panel.

Accordingly, while current power latch, power cinch, and power present assemblies are sufficient to meet regulatory requirements and provide enhanced comfort and convenience, a need still exists to advance the technology and provide alternative power latch, power cinch, and power present assemblies that address and overcome at least some of the known shortcomings.

### SUMMARY

This section provides a general summary of the disclosure and is not intended to be a comprehensive disclosure of all features, advantages, aspects and objectives associated with the inventive concepts described and illustrated in the detailed description provided herein.

It is an aspect of the present disclosure to provide a power latch and cinch assembly for a motor vehicle closure system configured to provide a latching and cinch system that addresses and overcomes at least the shortcomings discussed above.

It is a further aspect of the present disclosure to provide a power latch, power cinch, and power present assembly for a motor vehicle closure system configured to provide a latching, cinching, and presenting system that addresses and overcomes at least the shortcomings discussed above.

In accordance with another aspect, a latch and cinch assembly for a motor vehicle closure member moveable between a closed position, a partially open position, and a fully open position includes: a latch housing containing a ratchet and a pawl, wherein the pawl is moveable between a ratchet releasing position, whereat the ratchet is moveable to an open position to allow the closure member to be moved to the fully open position, a secondary ratchet holding position, whereat the ratchet is held in a secondary striker capture position by the pawl, whereat the closure member is held in the partially open position, and a primary ratchet holding position, whereat the ratchet is held in a primary striker capture position by the pawl, whereat the closure member is held in the closed position. Latch and cinch assembly further includes an auxiliary housing, also referred to as cinch housing, containing a cinch actuator, with the cinch actuator being energizable to move a cinch mechanism from a home position to a cinched position, whereat a cinch cable of the cinch mechanism moves the ratchet from the secondary striker capture position to the primary striker capture position. The cinch housing is releasably fixed to the latch housing, thereby rendering the latch and cinch assembly modular, in that a different size and style cinch housing can be releasably fixed to the latch housing, and vice versa.

In accordance with another aspect of the disclosure, a method of assembling a latch and cinch assembly includes: providing a latch housing containing a ratchet and a pawl, with the pawl being moveable between a ratchet releasing position, whereat the ratchet is moveable to an open position to allow a closure member to be moved to a fully open position, a secondary ratchet holding position, whereat the ratchet is held in a secondary striker capture position by the pawl, whereat the closure member is held in a partially open position, and a primary ratchet holding position, whereat the ratchet is held in a primary striker capture position by the pawl, whereat the closure member is held in a closed position. Further, providing a cinch housing separate from the latch housing, with the cinch housing containing a cinch actuator being energizable to move a cinch mechanism from a home position to a cinched position, whereat a cinch cable of the cinch mechanism moves the ratchet from the secondary striker capture position to the primary striker capture position. Further yet, attaching the cinch housing to said latch housing.

In accordance with another aspect of the disclosure, a method of assembling a power latch and cinch assembly to a closure member, includes: providing a latch housing containing a ratchet and a pawl, wherein the pawl is moveable between a ratchet releasing position, whereat the ratchet is moveable to an open position to allow a closure member to be moved to a fully open position, a secondary ratchet holding position, whereat the ratchet is held in a secondary striker capture position by the pawl, whereat the closure member is held in a partially open position, and a primary ratchet holding position, whereat the ratchet is held in a primary striker capture position by the pawl, whereat the closure member is held in a closed position. Further, providing a cinch housing separate from the latch housing, wherein the cinch housing contains a cinch actuator, with the cinch actuator being energizable to move a cinch mechanism from a home position to a cinched position, whereat a cinch cable of the cinch mechanism moves the ratchet from the secondary striker capture position to the primary striker capture position. Further yet, attaching the cinch housing to the latch housing, and then attaching the latch housing directly to the closure member without attaching the cinch housing directly to the closure member.

In accordance with another aspect of the disclosure, a latch assembly for a motor vehicle closure member moveable between a closed position, a partially open position, and a fully open position is provided. The latch assembly includes a latch housing containing a ratchet and a pawl. The pawl being movable between a ratchet releasing position, whereat the ratchet is moveable to an open position to allow the closure member to be moved to the fully open position, a secondary ratchet holding position, whereat the ratchet is held in a secondary striker capture position by the pawl, whereat the closure member is held in the partially open position, and a primary ratchet holding position, whereat the ratchet is held in a primary striker capture position by the pawl, whereat the closure member is held in the closed position. Further including an auxiliary housing containing an actuator. The actuator being energizable during a cinching operation to move a cinch mechanism from a home position to a cinched position, whereat a cinch cable of the cinch mechanism moves the ratchet from the secondary striker capture position to the primary ratchet holding position, and wherein the auxiliary housing is releasably fixed to the latch housing.

In accordance with another aspect of the disclosure, the auxiliary housing bounds an interior containing the actuator and the latch housing bounds and interior containing the ratchet and the pawl, wherein the interior of the auxiliary housing is separate from and not in communication with the interior of the latch housing.

In accordance with another aspect of the disclosure, the latch assembly further includes a cinch lever having a first end pivotably supported in the interior of the latch housing, the cinch lever extending outwardly from the interior of the latch housing to a second end.

In accordance with another aspect of the disclosure, the latch assembly further includes a cinch link pivotably coupled to the cinch lever adjacent the second end of the cinch lever, the cinch link extending from the cinch lever into the interior of the latch housing for selective engagement with the ratchet to move the ratchet from the secondary striker capture position to the primary ratchet holding position.

In accordance with another aspect of the disclosure, the cinch cable is attached directly to the cinch lever.

In accordance with another aspect of the disclosure, the actuator is energizable during a presenting operation to move a present mechanism from a home position to a present position, whereat a present cable of the present mechanism moves said ratchet from the primary striker capture position toward the open position.

In accordance with another aspect of the disclosure, the cinch cable has a first end attached to a drive member and a second end attached to the cinch link, and further including a present lever fixed for pivot movement within the latch housing, the present cable having a first end attached to the drive member and a second end attached to a first end of the present lever, the present lever having a second end configured to drive the ratchet from the primary striker capture position toward the striker release position.

In accordance with another aspect of the disclosure, the drive member is a drive pulley, the cinch cable arranged to be wrapped about a cinch groove of the drive pulley as the drive pulley moves from a home position to a cinch position during the cinching operation, and wherein the present cable is arranged to wrap about a present groove of the drive pulley as the drive pulley moves from a home position to a present position during the presenting operation.

In accordance with another aspect of the disclosure, the latch assembly further includes a gear reduction, wherein the drive pulley is fixed to an output gear of the gear reduction.

In accordance with another aspect of the disclosure, the actuator drives a worm in a first direction, causing the output gear to be driven in a first direction during the cinching operation, and wherein the actuator drives the worm in a second direction, causing the output gear to be driven in a second direction, opposite the first direction, during the presenting operation.

In accordance with another aspect of the disclosure, a latch, cinch and present assembly for a motor vehicle closure member moveable between a closed position, a partially open position, and a fully open position is provided. The latch, cinch and present assembly includes a latch housing containing a ratchet and a pawl. The pawl being moveable between a ratchet releasing position, whereat the ratchet is moveable to striker release position to allow the closure member to be moved to the fully open position, a secondary ratchet holding position, whereat the ratchet is held in a secondary striker capture position by the pawl, whereat the closure member is held in the partially open position, and a primary ratchet holding position, whereat the ratchet is held in a primary striker capture position by the pawl, whereat the closure member is held in the closed position. The latch, cinch and present assembly further includes a housing containing a cinch and present actuator. The cinch and present actuator being energizable to move a cinch and present mechanism from a home position to a cinch position, whereat a cinch cable of the cinch and present mechanism moves the ratchet from the secondary striker capture position to the primary striker capture position, and the cinch and present actuator being energizable to move the cinch and present mechanism from the home position to a present position, whereat a present cable of the cinch and present mechanism moves the ratchet from the primary ratchet holding position toward the striker release position, wherein the housing is releasably fixed to the latch housing.

In accordance with another aspect of the disclosure, the latch assembly further includes a cinch lever having a first end pivotably supported in the interior of the latch housing, the cinch lever extending outwardly from the interior of the latch housing to a second end coupled to the cinch cable, and a present lever fixed for pivot movement within the latch housing, the present lever having a first end coupled to the present cable and a second end configured to drive the ratchet from the primary striker capture position toward the striker release position.

In accordance with another aspect of the disclosure, the latch assembly further includes a cinch link pivotably coupled to the cinch lever adjacent the second end of the cinch lever, the cinch link extending from the cinch lever for selective engagement with the ratchet to move the ratchet from the secondary striker capture position to the primary ratchet holding position.

In accordance with another aspect of the disclosure, the cinch cable has a first end attached to a drive member and a second end attached directly to the cinch link, and wherein the present cable has a first end attached to the drive member and a second end attached directly to the present lever.

In accordance with another aspect of the disclosure, the drive member is a pulley, the cinch cable being configured to wrap about a cinch groove of the pulley as the pulley moves from a home position to a cinch position during the cinching operation, and the present cable configured to wrap about a present groove of the pulley as the pulley moves from a home position to a present position during the presenting operation, the cinch groove being laterally offset from the present groove.

In accordance with another aspect of the disclosure, the cinch and present actuator is energizable during the cinching operation to rotate the pulley in a first direction from the home position to the cinch position, whereat the cinch cable drives the cinch link into engagement with the ratchet to move the ratchet from the secondary striker capture position to the primary ratchet holding position, and the cinch and present actuator is energizable during the presenting operation to rotate the pulley in a second direction, opposite the first direction, from the home position to the present position, whereat the present cable drives the present lever into engagement with the ratchet to move the ratchet from the primary striker capture position toward the striker release position.

In accordance with another aspect of the disclosure, a method of assembling a power latch assembly to a closure member is provided. The method includes providing a latch housing containing a ratchet and a pawl, the pawl being moveable between a ratchet releasing position, whereat the ratchet is moveable to an open position to allow a closure member to be moved to a fully open position, a secondary ratchet holding position, whereat the ratchet is held in a secondary striker capture position by the pawl, whereat the closure member is held in a partially open position, and a primary ratchet holding position, whereat the ratchet is held in a primary striker capture position by the pawl, whereat the closure member is held in a closed position. Further, providing a housing separate from the latch housing, the housing containing an actuator, the actuator configured for actuation to drive a drive member during a cinching operation to move a cinch mechanism from a home position to a cinched position, whereat a cinch cable of the cinch mechanism moves the ratchet from the secondary striker capture position to the primary ratchet holding position. Further yet, attaching the cinch housing to the latch housing and attaching the latch housing directly to the closure member without attaching the cinch housing directly to the closure member.

In accordance with another aspect of the disclosure, the method further includes configuring the actuator to drive the drive member during a presenting operation to move a present mechanism from a home position to a present position, whereat a present cable of the present mechanism moves the ratchet from the primary ratchet holding position toward the open position.

In accordance with another aspect of the disclosure, the method further includes providing the drive member as a drive pulley fixed to an output gear of a gear reduction.

In accordance with another aspect of the disclosure, the method further includes providing the cinch cable for entrainment about the drive pulley to pull a cinch link configured for engagement with the ratchet during the cinching operation, and providing the present cable for entrainment about the drive pulley to pull a present lever configured for engagement with the ratchet during the presenting operation.

### BRIEF DESCRIPTION OF THE DRAWINGS

The drawings described herein are for illustrative purposes only of selected embodiments and not all possible implementations such that the drawings are not intended to limit the scope of the present disclosure.

FIG. 1 is an isometric view of a vehicle with a closure panel having a latch and cinch assembly according to an aspect of the disclosure;

FIG. 2 is an isometric back side view of the latch and cinch assembly of the vehicle of FIG. 1;

FIG. 3 is a front side plan view of the latch and cinch assembly of FIG. 2 with a ratchet illustrated in a primary striker capture position;

FIG. 4A fragmentary front side plan view of the latch and cinch assembly of FIG. 3 with the ratchet illustrated in a striker release position;

FIG. 4B is a view similar to FIG. 4A with a cover removed for clarity purposes only to better show a cinching operation with the ratchet illustrated in a secondary striker capture position;

FIG. 4C is a view similar to FIG. 4B with the ratchet illustrated cinched to the primary striker capture position;

FIG. 5 is an isometric back side view of a latch, cinch, and present assembly of the vehicle of FIG. 1 in accordance with another aspect of the disclosure;

FIG. 6A is a front side plan view of the latch, cinch, and present assembly of FIG. 5 with a ratchet illustrated in a primary striker capture position;

FIG. 6B is a side view of a drive member of the latch, cinch, and present assembly of FIG. 5 with a cinch cable and a present cable coupled thereto;

FIG. 7 fragmentary front side plan view of the latch and cinch assembly of FIG. 5 with a cover removed for viewing internal components, with a ratchet illustrated in a striker release position;

FIG. 8 is a view similar to FIG. 7 with the ratchet illustrated in a secondary striker capture position;

FIG. 9 is a view similar to FIG. 8 with the ratchet illustrated cinched to a cinch position beyond a primary striker capture position;

FIG. 10 is a view similar to FIG. 9 with the ratchet illustrated in the primary striker capture position;

FIG. 11 is a view similar to FIG. 10 with the ratchet illustrated presented to an intermediate position between the primary striker capture position and the striker release position; and

FIG. 12 is a view similar to FIG. 11 with the ratchet illustrated in the striker release position.

### DETAILED DESCRIPTION OF EXEMPLARY EMBODIMENTS

Example embodiments will now be described more fully with reference to the accompanying drawings. To this end, the example embodiments are provided so that this disclosure will be thorough, and will fully convey its intended scope to those who are skilled in the art. Accordingly, numerous specific details are set forth such as examples of specific components, devices, and methods, to provide a thorough understanding of embodiments of the present disclosure. However, it will be apparent to those skilled in the art that specific details need not be employed, that example embodiments may be embodied in many different forms, and that neither should be construed to limit the scope of the present disclosure. In some example embodiments, well-known processes, well-known device structures, and well-known technologies are not described in detail.

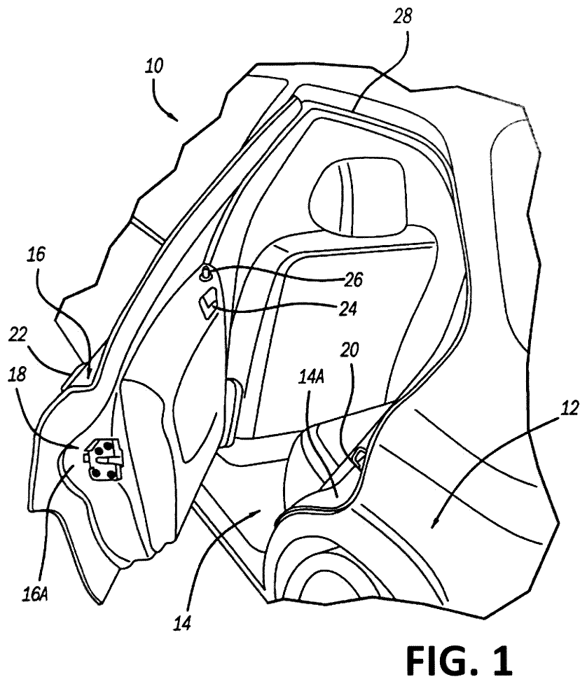

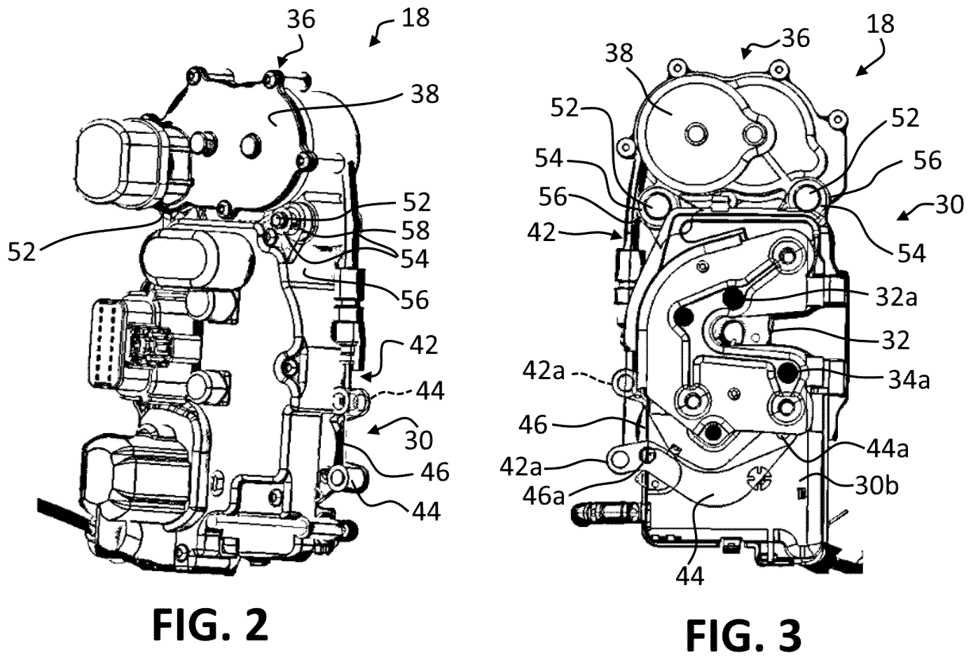

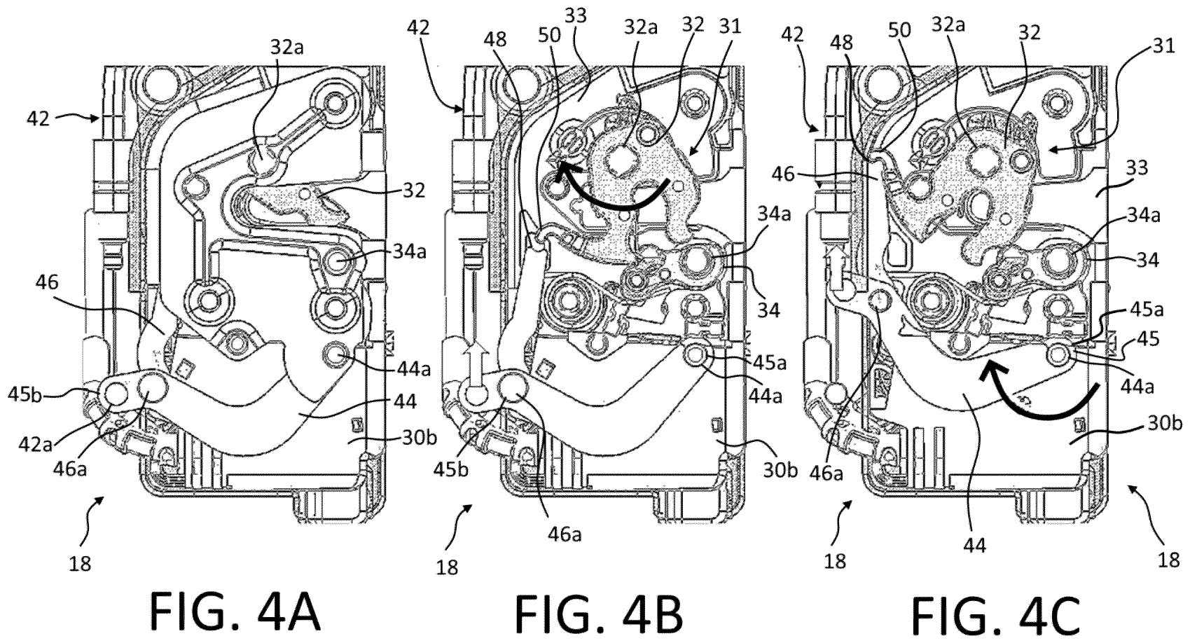

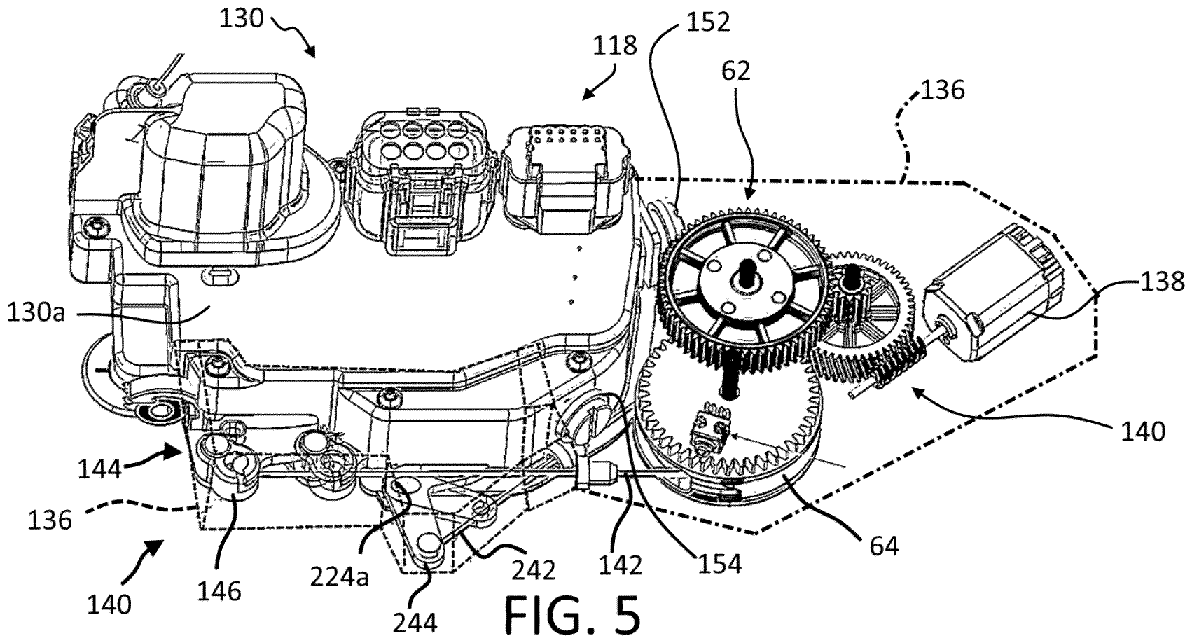

Referring initially to FIG. 1 of the drawings, a motor vehicle 10 is shown to include a vehicle body 12 defining an opening 14 to an interior passenger compartment. A closure panel, also referred to as closure member 16 (such as a swing door as shown, but which may be other vehicle closure panels), is pivotably mounted to body 12 for movement between an open position (shown), a partially open or partially closed position, and a fully closed position to respectively open and close opening 14. A power latch and cinch assembly, also referred to for simplicity as power latch assembly 18, is rigidly secured to closure member 16 adjacent to an edge portion 16A thereof and is releasably engageable with a striker 20 that is fixedly secured to a recessed edge portion 14A of opening 14. As will be detailed, power latch assembly 18 is operable to engage striker 20 and releasably move closure panel 16 from the partially open position into its fully closed position. An outside handle 22 and an inside handle 24 are provided for actuating power latch assembly 18 to release striker 20 and permit subsequent movement of closure panel 16 to its open position. One or both of the outside handle 22 or inside handle 24 may also manually actuate the power latch assembly 18. An optional lock knob 26 is shown which provides a visual indication of the locked state of power latch assembly 18 and which may also be operable to mechanically change the locked state of latch assembly 18. A weather seal 28 is mounted on edge portion 14A of opening 14 in vehicle body 12 and is adapted to be resiliently compressed upon engagement with a mating sealing surface of closure member 16 when closure member 16 is held by power latch assembly 18 in its closed position so as to provide a sealed interface therebetween which is configured to prevent entry of rain and dirt into the passenger compartment while minimizing audible wind noise.

Power latch assembly 18 includes a first housing, also referred to as latch housing 30, having an interior 33 sized to contain a latch mechanism 31 including, by way of example and without limitation, a ratchet 32 and a pawl 34, therein. The latch housing 30 is shown having a latch housing cover 30a and a frame plate 30b, with ratchet 32 and pawl 34 being supported by at least frame plate 30b for rotation about respective ratchet and pawl pins 32a, 34a. The pawl 34 is moveable between a ratchet releasing position, whereat ratchet 32 is moveable to a striker release position, also referred to as an open position, to allow release of striker 20, thereby allowing the closure member 16 to be moved to the fully open position, a secondary ratchet holding position, whereat ratchet 32 is held in a secondary striker capture position by pawl 34, whereat the closure member 16 is held in the partially open position, and a primary ratchet holding position, whereat ratchet 32 is held in a primary striker capture position by pawl 34, whereat the closure member 16 is held in the closed position.

Power latch assembly 18 further includes an auxiliary housing, also referred to as second housing or cinch housing 36, releasably fixed to the latch housing 30. The cinch housing 36 bounds an interior 37 sized to contain a cinch actuator 38 and at least a portion of a cinch mechanism 40. The interior 37 bounded by the cinch housing 36 is separate from and not in communication with the interior 33 bounded by the latch housing 30, such that the cinch housing 36 and the latch housing 30 are separate from one another, other than being attached to one another, as discussed further below. The cinch actuator 38 is selectively energizable to move cinch mechanism 40 from a home position to a cinched position, whereat a cinch cable 42 of the cinch mechanism 40, operably connecting cinch actuator 38 to ratchet 32, moves ratchet 32 from the secondary striker capture position to the primary ratchet holding position during a cinching operation. The cinch mechanism 40 can include any desired connection features to operably couple cinch cable 42 to cinch actuator 38, and can further include a gear train, also referred to as gear reduction, to provide the desired cinch force on ratchet 32. Cinch cable 42 extends from cinch housing 36 to latch housing 30, shown as extending in outwardly exposed relation therefrom, to interconnect cinch mechanism 40 with ratchet 32.

A cinch lever 44, illustrated as being generally L or V-shaped, by way of example and without limitation, has a first end 45a fixed for pivot movement within the interior 33 of latch housing 30 about a cinch lever pin 44a, with cinch lever 44 extending outwardly from the interior 33 to a second end 45b. Cinch cable 42 is shown, by way of example and without limitation, having an end 42a coupled directly to the second end 45b of cinch lever 44 outwardly from the interior 33 of latch housing 30. A cinch link 46 has an attachment end, also referred to as first end, fixed for pivot movement to cinch lever 44 about a cinch link pin 46a. Cinch link 46 extends from the cinch lever 44 inwardly into the interior 33 to a drive end, also referred to a second end 48 configured to selectively engage and drive ratchet 32 from the secondary striker capture position to the primary striker capture position during the cinching process. In the illustrated non-limiting embodiment, second end 48 is shown arranged to engage a driven arm 50 of ratchet 32 during the cinching process.

Cinch housing 36 is releasably fixed to the latch housing 30 by an attachment mechanism including at least one, and shown as a plurality of fasteners 52. The cinch housing 36 and cinch mechanism 40 housed therein can be pre-assembled as a separate subassembly from latch housing 30 and the contents contained in latch housing 30, and then can be subsequently attached to latch housing 30 via the one or more fasteners 52. The fastener(s) 52 are disposed through one or more fastener receptacle(s) 54 of the latch housing 30 and one or more fastener receptacle(s) 56 of the cinch housing 36, wherein the respective latch and cinch receptacles 54, 56 can be universally sized, shaped, and located/positioned for coupled alignment and attachment with one another via the corresponding fastener(s) 52. Accordingly, the attachment mechanism, namely, the size and location of respective latch and cinch receptacles 54, 56 and associated fasteners 52 are universal, such that any configuration of latch housing 30 and cinch housing 36 can be provided for attachment with one another in accordance with this disclosure, as will be readily understood by a person possessing ordinary skill in the art upon viewing the disclosure herein. Accordingly, the cinch housing 36 and cinch mechanism 40 can be readily attached to latch housing 30 in a “plug-and-play” type assembly process. Accordingly, the size, type, model, etc., of each housing 30, 36 can be varied/changed and customized independently from one another to provide the desired latch and cinch assembly, as desired for the intended vehicle platform, without necessarily having to redesign both latch and cinch housings 30, 36. Further, to prevent noise and vibration, a plurality of dampeners 58, such as elastomeric O-rings, also referred to as washers or bushings, can be disposed between the cinch receptacle(s) 56 and the latch receptacle(s) 54. In the non-limiting embodiment illustrated, the cinch receptacles 56 are shown as a pair of cylindrical receptacles, with the latch receptacles shown as two pairs of flanges, with each pair of flanges 54 being configured for receipt of a corresponding cylindrical cinch receptacles 56 therebetween. The dampeners 58 are disposed on opposite ends of the cylindrical cinch receptacles 56 between the cinch receptacle 56 and the pair of corresponding latch receptacles 54, such that four dampeners 58 are provided in the non-limiting embodiment illustrated. Latch housing 30 can be fixed directly to the closure member 16, while cinch housing 36 is indirectly coupled to the closure member 16 via latch housing 30.

In accordance with another aspect of the disclosure, a method of assembling a power latch and cinch assembly 18 includes: providing a latch housing 30 containing a ratchet 32 and a pawl 34, wherein the pawl 34 is moveable between a ratchet releasing position, whereat the ratchet 32 is moveable to an open position to allow a closure member 16 to be moved to a fully open position, a secondary ratchet holding position, whereat the ratchet 32 is held in a secondary striker capture position by the pawl 34, whereat the closure member 16 is held in a partially open position, and a primary ratchet holding position, whereat the ratchet 32 is held in a primary striker capture position by the pawl 34, whereat the closure member 16 is held in a closed position. Further, providing a cinch housing 36 separate from the latch housing 30, wherein the cinch housing 36 contains a cinch actuator 38, with the cinch actuator 38 being energizable to move a cinch mechanism 40 from a home position to a cinched position, whereat a cinch cable 42 of the cinch mechanism 40 moves the ratchet 32 from the secondary striker capture position to the primary ratchet holding position. Further yet, attaching the cinch housing 36 to the latch housing 30.

In accordance with another aspect of the disclosure, a method of assembling a power latch and cinch assembly 18 to a closure member 16, includes: providing a latch housing 30 containing a ratchet 32 and a pawl 34, wherein the pawl 34 is moveable between a ratchet releasing position, whereat the ratchet 32 is moveable to an open position to allow a closure member 16 to be moved to a fully open position, a secondary ratchet holding position, whereat the ratchet 32 is held in a secondary striker capture position by the pawl 34, whereat the closure member 16 is held in a partially open position, and a primary ratchet holding position, whereat the ratchet 32 is held in a primary striker capture position by the pawl 34, whereat the closure member 16 is held in a closed position. Further, providing a cinch housing 36 separate from the latch housing 30, wherein the cinch housing 36 contains a cinch actuator 38, with the cinch actuator 38 being energizable to move a cinch mechanism 40 from a home position to a cinched position, whereat a cinch cable 42 of the cinch mechanism 40 moves the ratchet 32 from the secondary striker capture position to the primary ratchet holding position. Further yet, attaching the cinch housing 36 to the latch housing 30, and then attaching the latch housing directly to the closure member 16 without attaching the cinch housing 36 directly to the closure member 16.

In accordance with another aspect of the disclosure, power latch assembly 118 is provided, wherein the same reference numerals, offset by a factor of 100, are used to identify like features. Power latch assembly 118 is operable to forcibly engage striker 20 and move closure panel 16 from the partially open position into its fully closed position, similarly as discussed above for power latch assembly 18, and is further operable to forcibly engage striker 20 and move closure panel 16 from the fully closed position toward its open position.

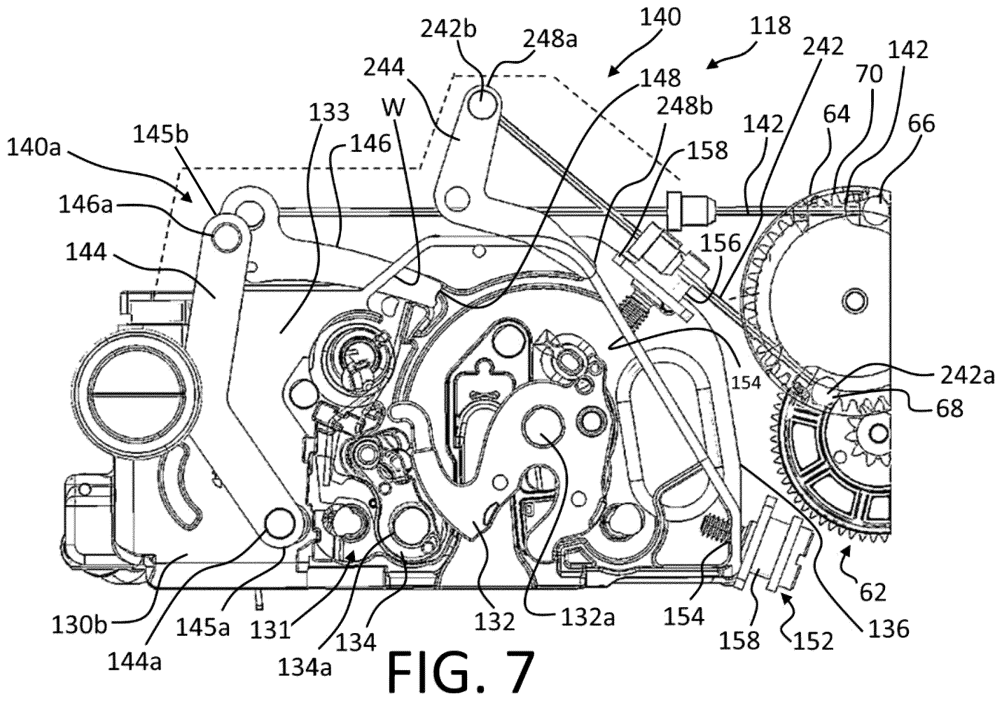

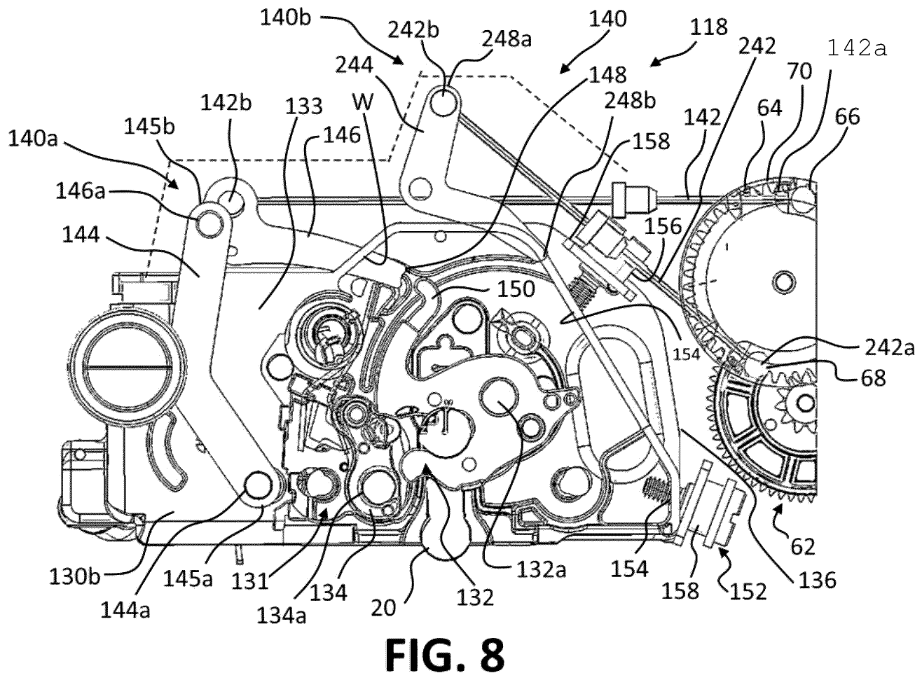

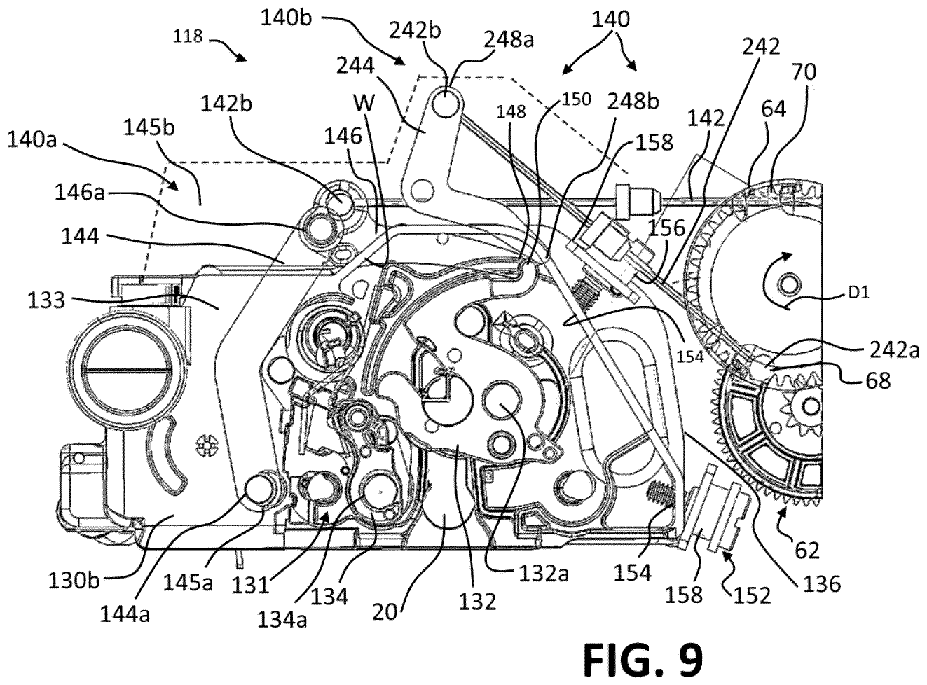

Power latch assembly 118 includes a first housing, also referred to as latch housing 130, containing a latch mechanism 131 including, by way of example and without limitation, a ratchet 132 and a pawl 134, therein. The latch housing 130 is shown having a latch housing cover 130a and a frame plate 130b, with ratchet 132 and pawl 134 being supported by at least frame plate 130b for rotation about respective ratchet and pawl pins 132a, 134a (shown in FIG. 7 only to avoid cluttering FIGS. 8-12). The pawl 134 is moveable between a ratchet releasing position (FIGS. 7, 11, and 12), whereat ratchet 132 is moveable to a striker release position, also referred to an open position, to allow release of striker 20, thereby allowing the closure member 16 to be moved to the fully open position, a secondary ratchet holding position (FIG. 8), whereat ratchet 132 is held in a secondary striker capture position by pawl 134, whereat the closure member 16 is held in the partially open position, and a primary ratchet holding position (FIGS. 9, with ratchet 132 shown in a cinch position, and 10), whereat ratchet 132 is held in a primary striker capture position by pawl 134, whereat the closure member 16 is held in the closed position.

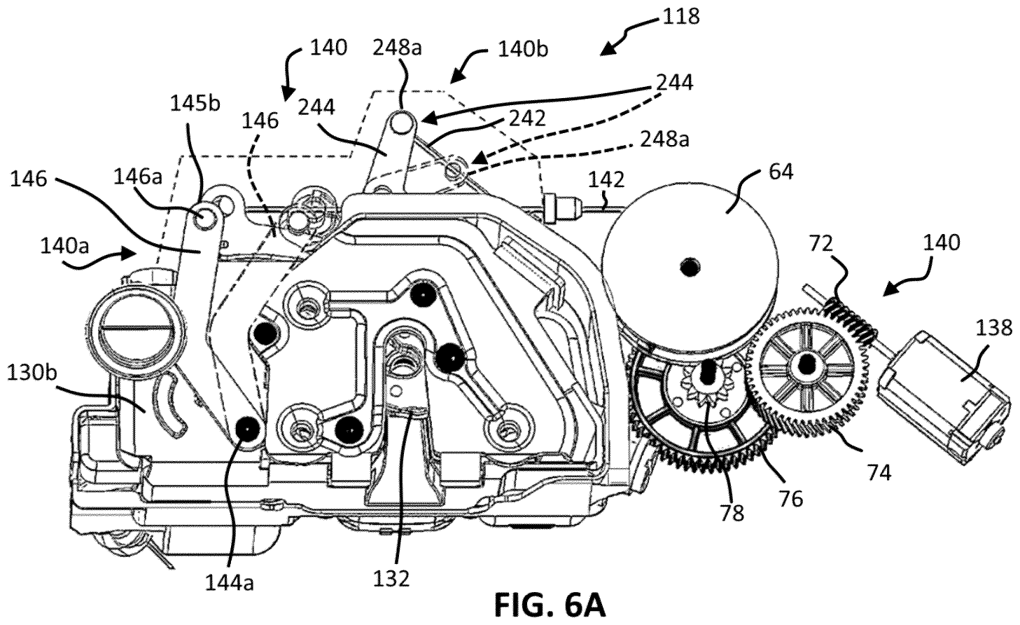

Power latch assembly 118 further includes an auxiliary housing, also referred to as second housing or cinch and present actuator assembly housing, and referred to hereafter as cinch/present housing 136 (FIG. 5) releasably fixed to the latch housing 130. The cinch/present housing 136 contains and protects a cinch and present actuator, referred to hereafter as cinch/present actuator 138, and at least a portion of a cinch and present mechanism, referred to hereafter as cinch/present mechanism 140. The interior bounded by the cinch/present housing 136 is not in open communication with the interior bounded by the latch housing 130, such that the cinch/present housing 136 and the latch housing 130 are separate from one another, and can be sealed from one another by a sealed interface therebetween, other than being attached to one another, as discussed further below. The cinch/present actuator 138 is selectively energizable to move cinch/present mechanism 140 to perform one of a cinch operation or a present operation, such as to break ice in an ice breaking operation, for example, depending on the operation desired at the moment.

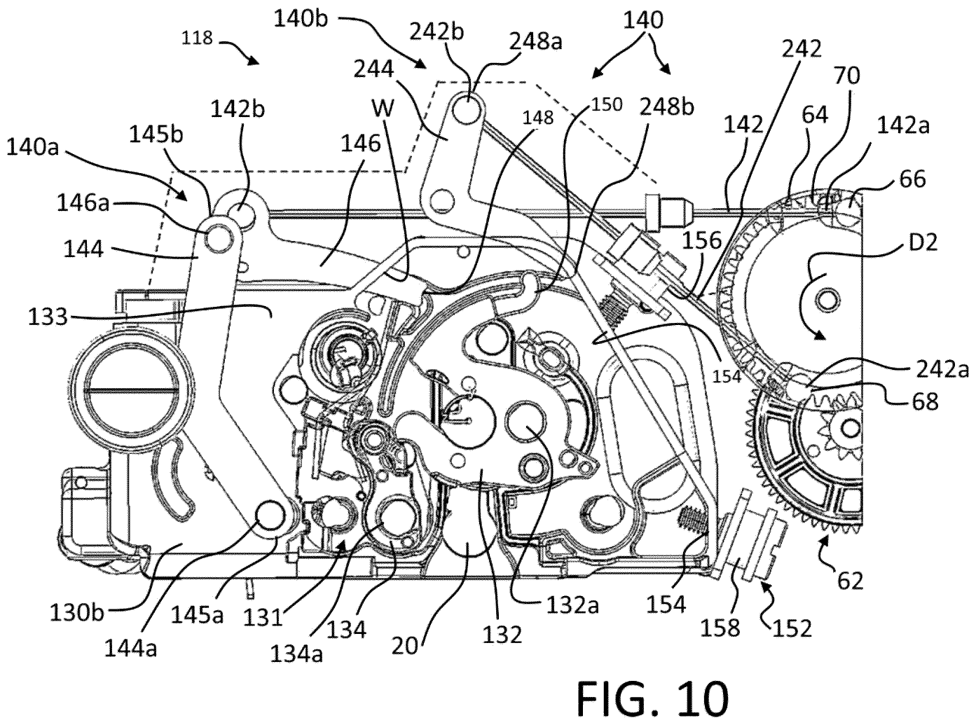

In an instance when the cinch operation is desired, cinch/present actuator 138 is energizable to move from a home position to a cinched position, whereat a cinch cable 142 of a cinch mechanism 140a, operably connecting cinch/present actuator 138 to ratchet 132, moves ratchet 132 from the secondary striker capture position (FIG. 8) to a cinched striker capture position (FIG. 9), whereupon the ratchet 132 returns to the primary holding position (FIG. 10) during a cinching operation. The cinch mechanism 140a can include any desired connection features to operably couple cinch cable 142 to cinch/present actuator 138, and is shown including multiple gears in meshed engagement with one another, referred to as a gear train, also referred to as gear reduction 62, to provide the desired rotational speed of ratchet 132 and cinch force applied to and by ratchet 132. Cinch cable 142 extends within cinch/present housing 136 and in outwardly exposed relation from cinch/present housing 136 and latch housing 130, to interconnect cinch mechanism 140a with ratchet 132.

Cinch cable 142 is shown, by way of example and without limitation, having a first end 142a coupled directly to a cinch and present drive member, also referred to as drive member, such as via a cinch ferrule 66 fixed to the first end 142a of cinch cable 142, with cinch ferrule 66 fixedly received in a notch of drive member 64, wherein drive member is shown as a drive pulley 64, by way of example and without limitation, and a second end 142b coupled directly to a cinch lever 144. Cinch lever 144 is illustrated as being generally L or V-shaped, by way of example and without limitation, with cinch lever 144 having a first end 145a fixed for pivot movement within the interior 133 of latch housing 130 about a cinch lever pin 144a, with cinch lever 144 extending outwardly from the interior 133 to a second end 145b. A cinch link 146 has an attachment end, also referred to as first end, fixed for pivot movement to cinch lever 144 about a cinch link pin 146a outwardly from the interior 133 immediately adjacent the second end 145b of cinch lever 144. Cinch link 146 extends from the cinch lever 144 through a window (W), which can be sealed via an elastomeric grommet, by way of example and without limitation, to a drive end, also referred to a second end 148 located within the interior 133 and configured to forcibly and selectively engage and drive ratchet 132 from the secondary striker capture position (FIG. 8) to the cinched striker capture position (FIG. 9), and then allow ratchet 132 to return under a bias of a ratchet biasing member to the primary striker capture position (FIG. 10) during the cinching process. In the illustrated non-limiting embodiment, second end 148 is shown arranged to engage a driven arm 150 of ratchet 132 during the cinching process.

During the cinching process, with ratchet 132 in the secondary striker capture position (FIG. 8), cinch/present actuator 138 is selectively energized to move in a first direction, thereby driving gear train 62 in a first direction, also referred to as cinch direction, whereupon drive pulley 64 is driven in a first direction D1, also referred to as cinch direction, from a home position (FIG. 8) to a cinch position (FIG. 9). As drive pulley 64 rotates in the first direction D1 from the home position to the cinch position, cinch cable 142 is wrapped about a portion of drive pulley 64, thereby causing cinch link 146 to be pulled from a neutral, home position by cinch cable 142, whereupon cinch lever 144 is rotated about cinch lever pin 144a in conjoint movement with cinch link 146. Second end 148 of cinch link 146 is moved into forcible engagement with driven arm 150 of ratchet 132, whereupon ratchet 132 is forcibly driven from the secondary striker capture position to the cinched striker capture position. Then, upon completion of the cinching operation, cinch/present actuator 138 is energized to move in a second direction, opposite the first direction, thereby causing gear train 62 to be driven in a second direction, opposite the cinch direction, whereupon drive pulley 64 is driven in a second direction D2, also referred to as cinch return direction, back to the home position (FIG. 8), whereupon ratchet 132 is free to return to the primary striker capture position.

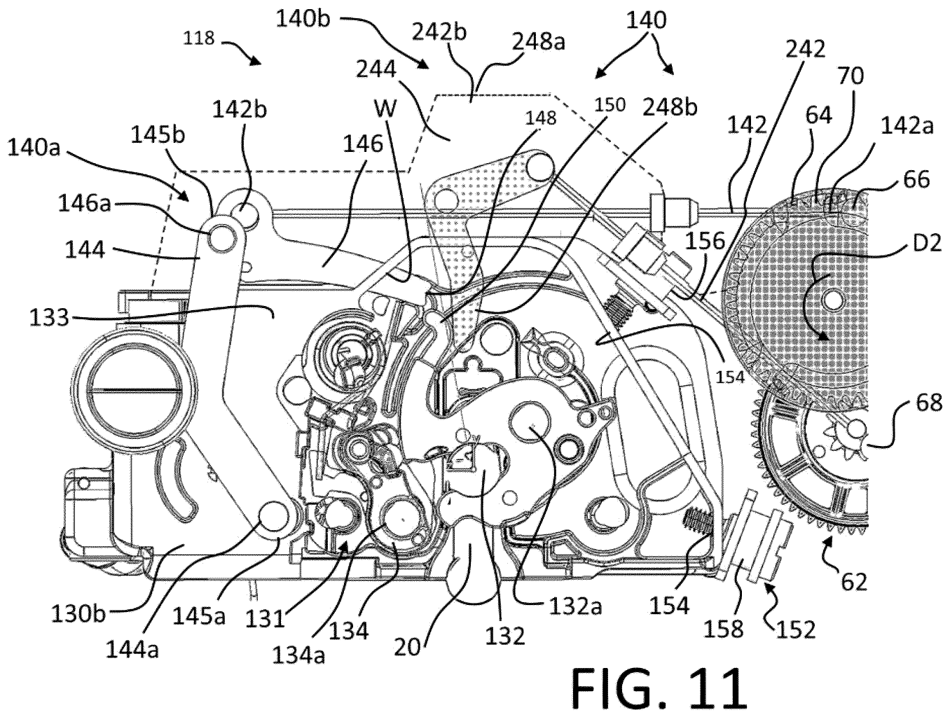

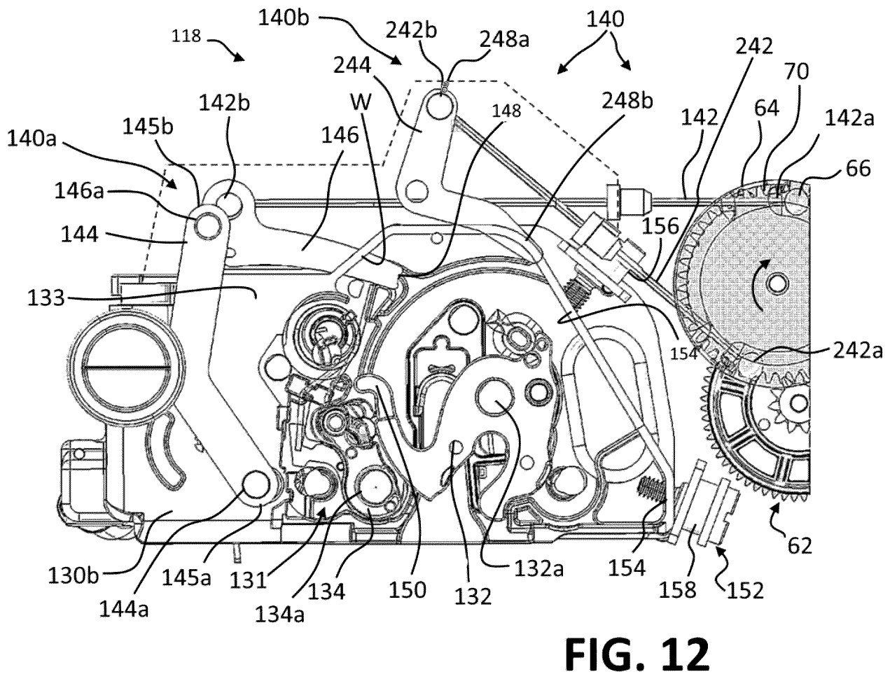

In an instance when the present (e.g. ice breaking) operation is desired, cinch/present actuator 138 is energizable to move from a home position to a presented position, whereat a present cable 242 of a present mechanism 140b, operably connecting cinch/present actuator 138 to ratchet 132, moves ratchet 132 from the primary striker capture position (FIG. 10) toward the striker release position (FIG. 11), whereupon the ratchet 132 is freed, such as from the breaking of ice, by way of example and without limitation, to continue to the striker release position (FIG. 12). The present mechanism 140b can include any desired connection features to operably couple present cable 242 to cinch/present actuator 138, and is shown including the gear reduction 62, to provide the desired present force on ratchet 132. Present cable 242 extends within cinch/present housing 136 and in outwardly exposed relation from cinch/present housing 136 and latch housing 130, to interconnect present mechanism 140b with ratchet 132.

Present cable 242 is shown, by way of example and without limitation, having a first end 242a coupled to drive pulley 64, such as via a present ferrule 68 fixed to the first end 242a of present cable 242, with present ferrule 68 fixedly received in a notch of drive member 64, and a second end 242b of present cable 242 coupled to a present lever 244. Present lever 244 is illustrated as being generally L or V-shaped, by way of example and without limitation, with present lever 244 being fixed for pivot movement within latch housing 130 about a present lever pin 244a (FIG. 5). Present lever 244 has first end 248a coupled directly to the second end 242b of present cable 242 and a drive end, also referred to a second end 248b configured to forcibly engage and drive ratchet 132 from the primary striker capture position (FIG. 10) toward the striker release position (FIG. 11), whereupon ratchet 132 is free to the striker release position (FIG. 12) during the presenting process.

During the presenting process, with ratchet 132 in the primary striker capture position (FIG. 10), cinch/present actuator 138 is selectively energized to move in a second direction, opposite the first direction discussed above for the cinching operation, thereby driving gear train 62 in a second direction, also referred to as present direction, whereupon drive pulley 64 is driven in the second direction D2, also referred to as present direction, from a home position (FIG. 10) to a present position (FIG. 11). As drive pulley 64 rotates in the second direction D2 from the home position to the present position, present lever 244 is pulled from a neutral, home position by present cable 242, whereupon present lever 244 is rotated about present lever pin 244a. Second end 248b of present lever 244 is moved into forcible engagement with driven arm 150 of ratchet 132, whereupon ratchet 132 is forcibly driven from the primary striker capture position toward the striker release position. Then, upon completion of the presenting operation, cinch/present actuator 138 is energized to move in the first direction, opposite the second direction, thereby causing gear train 62 to be driven in the first direction, whereupon drive pulley 64 is driven in the first direction D1, also referred to as present return direction, back to the home position (FIG. 12).

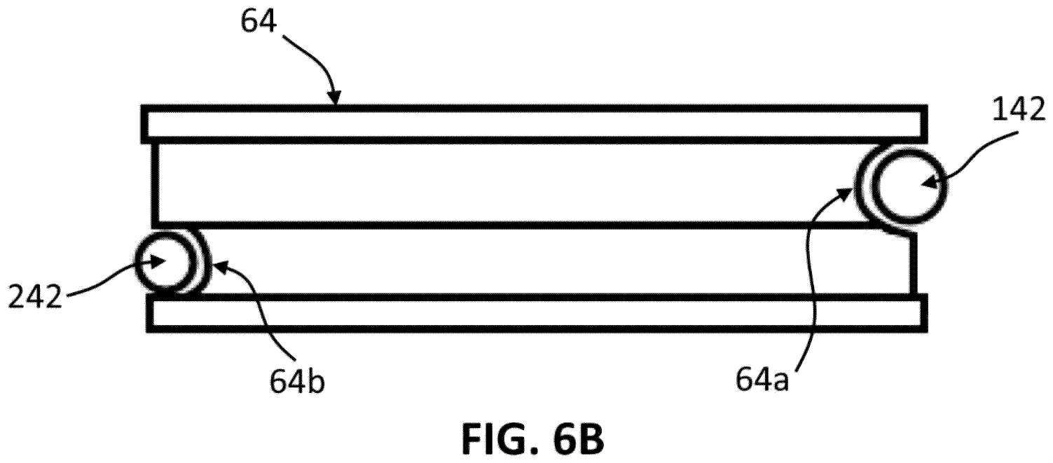

It is to be understood that the gear train 62 can be provided having the desired speed and torque output at an output gear 70 and at drive pulley 64 by selecting the individual gears of a meshed gear arrangement thereof having the number of teeth and diameter needed to provide the speed and torque output desired, as will be understood by a person possessing ordinary skill in the art upon viewing the disclosure herein. As best seen in FIG. 6A, drive pulley 64 is illustrated fixed for conjoint rotation with output gear 70, while cinch/present actuator 138 drives a worm 72 to drive gear train 62. In particular, worm 72 is illustrated in meshed engagement with a first driven gear 74, which in turn drives a an intermediate gear, also referred to as second driven gear 76, via a first pinion gear (not shown) fixed to first driven gear 74 for conjoint, concentric, coaxial rotation therewith. Second driven gear 76 drives output gear 70 via a second pinion gear 78 fixed to second driven gear 76, with second pinion gear 78 being arranged in meshed engagement with output gear 70.

As shown in FIG. 6B, cinch and present pulley, referred to as drive pulley 64, is provided having non-overlapping, axially offset, also referred to as laterally offset, relative to an axis of rotation of drive pulley 64, grooves 64a, 64b. Groove 64a, also referred to as cinch groove, is configured for cinch cable 142 to be entrained therein, while groove 64b, also referred to as present groove, is configured for present cable 242 to be entrained therein. Accordingly, cinch cable 142 and present cable 242 are maintained out of interference with one another during the respective cinching and presenting operations.

Cinch/present housing 136 is releasably fixed to the latch housing 130 by at least one, and shown as a plurality of fasteners 152. Fasteners 152 can be provided as threaded fasteners having dampening insulators, also referred to as dampeners 158, such as rubber, by way of example and without limitation, thereby minimizing any potential for noise generation. The cinch/present housing 136 and cinch/present mechanism 140 housed therein can be pre-assembled as a subassembly, and then can be subsequently attached to latch housing 130 via fasteners 152. The fastener(s) 152 are disposed through one or more fastener receptacle(s), also referred to as latch receptacles 154, of the latch housing 130 and one or more fastener receptacle(s), also referred to as cinch/present receptacles 156, of the cinch/present housing 136, wherein the respective latch and cinch/present receptacles 154, 156 can be universally sized, shaped, and located for coupled alignment and attachment with one another via the corresponding fastener(s) 152. Accordingly, the cinch/present housing 136 and cinch/present mechanism 140 can be attached to latch housing 130 in a plug-and-play type assembly process. Accordingly, the size, type, model, etc., of each housing 130, 136 can be varied/changed to provide the desired latch and cinch assembly, as desired for the intended vehicle platform, without having to redesign the respective latch and cinch/present housings 130, 136. Further, to prevent noise and vibration, the plurality of dampeners 158, such as elastomeric O-rings, also referred to as washers or bushings, can be disposed between the cinch/present receptacle(s) 156 and the latch receptacle(s) 154. Latch housing 130 can be fixed directly to the closure member 16, while cinch/present housing 136 is indirectly coupled to the closure member 16 via latch housing 130.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A latch assembly for a motor vehicle closure member moveable between a closed position, a partially open position, and a fully open position, comprising:
a latch housing containing a ratchet and a pawl, said pawl being moveable between a ratchet releasing position, whereat said ratchet is moveable to an open position to allow the closure member to be moved to the fully open position, a secondary ratchet holding position, whereat said ratchet is held in a secondary striker capture position by said pawl, whereat the closure member is held in the partially open position, and a primary ratchet holding position, whereat said ratchet is held in a primary striker capture position by said pawl, whereat the closure member is held in the closed position; and
an auxiliary housing containing an actuator, said actuator being energizable during a cinching operation to move a cinch mechanism from a home position to a cinched position, whereat a cinch cable of the cinch mechanism moves said ratchet from the secondary striker capture position to the primary ratchet holding position,
wherein said auxiliary housing is releasably fixed to said latch housing.

2. The latch assembly of claim 1, wherein the auxiliary housing bounds an interior containing the actuator and the latch housing bounds and interior containing the ratchet and the pawl, wherein the interior of the auxiliary housing is separate from and not in communication with the interior of the latch housing.

3. The latch assembly of claim 2, further including a cinch lever having a first end pivotably supported in the interior of the latch housing, the cinch lever extending outwardly from the interior of the latch housing to a second end.

4. The latch assembly of claim 3, further including a cinch link pivotably coupled to the cinch lever adjacent the second end of the cinch lever, the cinch link extending from the cinch lever into the interior of the latch housing for selective engagement with the ratchet to move the ratchet from the secondary striker capture position to the primary ratchet holding position.

5. The latch assembly of claim 4, wherein the cinch cable is attached directly to the cinch lever.

6. The latch assembly of claim 4, wherein the actuator is energizable during a presenting operation to move a present mechanism from a home position to a present position, whereat a present cable of the present mechanism moves said ratchet from the primary striker capture position toward the open position.

7. The latch assembly of claim 6, wherein the cinch cable has a first end attached to a drive member and a second end attached to the cinch link, and further including a present lever fixed for pivot movement within the latch housing, the present cable having a first end attached to the drive member and a second end attached to a first end of the present lever, the present lever having a second end configured to drive the ratchet from the primary striker capture position toward the striker release position.

8. The latch assembly of claim 6, wherein the drive member is a drive pulley, the cinch cable arranged to be wrapped about a cinch groove of the drive pulley as the drive pulley moves from a home position to a cinch position during the cinching operation, and wherein the present cable is arranged to wrap about a present groove of the drive pulley as the drive pulley moves from a home position to a present position during the presenting operation.

9. The latch assembly of claim 8, further including a gear reduction, wherein the drive pulley is fixed to an output gear of the gear reduction.

10. The latch assembly of claim 9, wherein the actuator drives a worm in a first direction, causing the output gear to be driven in a first direction during the cinching operation, and wherein the actuator drives the worm in a second direction, causing the output gear to be driven in a second direction, opposite the first direction, during the presenting operation.

11. A latch assembly for a motor vehicle closure member moveable between a closed position, a partially open position, and a fully open position, comprising:
a latch housing containing a ratchet and a pawl, said pawl being moveable between a ratchet releasing position, whereat said ratchet is moveable to striker release position to allow the closure member to be moved to the fully open position, a secondary ratchet holding position, whereat said ratchet is held in a secondary striker capture position by said pawl, whereat the closure member is held in the partially open position, and a primary ratchet holding position, whereat said ratchet is held in a primary striker capture position by said pawl, whereat the closure member is held in the closed position; and
a housing containing a cinch and present actuator, said cinch and present actuator being energizable to move a cinch and present mechanism from a home position to a cinch position, whereat a cinch cable of the cinch and present mechanism moves said ratchet from the secondary striker capture position to the primary striker capture position, and said cinch and present actuator being energizable to move the cinch and present mechanism from the home position to a present position, whereat a present cable of the cinch and present mechanism moves said ratchet from the primary ratchet holding position toward the striker release position,
wherein the housing is releasably fixed to said latch housing.

12. The latch assembly of claim 11, further including a cinch lever having a first end pivotably supported in the interior of the latch housing, the cinch lever extending outwardly from the interior of the latch housing to a second end coupled to the cinch cable, and a present lever fixed for pivot movement within the latch housing, the present lever having a first end coupled to the present cable and a second end configured to drive the ratchet from the primary striker capture position toward the striker release position.

13. The latch assembly of claim 12, further including a cinch link pivotably coupled to the cinch lever adjacent the second end of the cinch lever, the cinch link extending from the cinch lever for selective engagement with the ratchet to move the ratchet from the secondary striker capture position to the primary ratchet holding position.

14. The latch assembly of claim 13, wherein the cinch cable has a first end attached to a drive member and a second end attached directly to the cinch link, and wherein the present cable has a first end attached to the drive member and a second end attached directly to the present lever.

15. The latch assembly of claim 14, wherein the drive member is a pulley, the cinch cable being configured to wrap about a cinch groove of the pulley as the pulley moves from a home position to a cinch position during the cinching operation, and the present cable configured to wrap about a present groove of the pulley as the pulley moves from a home position to a present position during the presenting operation, the cinch groove being laterally offset from the present groove.

16. The latch assembly of claim 15, wherein the cinch and present actuator is energizable during the cinching operation to rotate the pulley in a first direction from the home position to the cinch position, whereat the cinch cable drives the cinch link into engagement with the ratchet to move the ratchet from the secondary striker capture position to the primary ratchet holding position, and the cinch and present actuator is energizable during the presenting operation to rotate the pulley in a second direction, opposite the first direction, from the home position to the present position, whereat the present cable drives the present lever into engagement with the ratchet to move the ratchet from the primary striker capture position toward the striker release position.

17. A method of assembling a power latch assembly to a closure member, comprising:
providing a latch housing containing a ratchet and a pawl, said pawl being moveable between a ratchet releasing position, whereat said ratchet is moveable to an open position to allow a closure member to be moved to a fully open position, a secondary ratchet holding position, whereat said ratchet is held in a secondary striker capture position by said pawl, whereat the closure member is held in a partially open position, and a primary ratchet holding position, whereat said ratchet is held in a primary striker capture position by said pawl, whereat the closure member is held in a closed position; and
providing a housing separate from said latch housing, the housing containing an actuator, said actuator configured for actuation to drive a drive member during a cinching operation to move a cinch mechanism from a home position to a cinched position, whereat a cinch cable of the cinch mechanism moves said ratchet from the secondary striker capture position to the primary ratchet holding position; and
attaching the cinch housing to said latch housing and attaching the latch housing directly to the closure member without attaching the cinch housing directly to the closure member.

18. The method of claim 17, further including configuring the actuator to drive the drive member during a presenting operation to move a present mechanism from a home position to a present position, whereat a present cable of the present mechanism moves said ratchet from the primary ratchet holding position toward the open position.

19. The method of claim 18, further including providing the drive member as a drive pulley fixed to an output gear of a gear reduction.

20. The method of claim 19, further including providing the cinch cable for entrainment about the drive pulley to pull a cinch link configured for engagement with the ratchet during the cinching operation, and providing the present cable for entrainment about the drive pulley to pull a present lever configured for engagement with the ratchet during the presenting operation.
